(19) United States
(12) Patent Application Publication
(10) Pub. No.: US 2013/0161258 A1
(43) Pub. Date: Jun. 27, 2013

(54) SANITARY BRINE SEAL

(71) Applicants: Dean David MARSCHKE, Minnetonka, MN (US); Michael J. MADSEN, Chaska, MN (US)

(72) Inventors: Dean David MARSCHKE, Minnetonka, MN (US); Michael J. MADSEN, Chaska, MN (US)

(73) Assignee: GENERAL ELECTRIC COMPANY, Schenectady, NY (US)

(21) Appl. No.: 13/333,309

(22) Filed: Dec. 21, 2011

(51) Int. Cl. B01D 63/10; F16J 15/02; B01D 61/00

(52) U.S. Cl. 210/650; 210/456; 277/628

(57) ABSTRACT

The present disclosure describes a brine seal for use with a spiral wound membrane element. The brine seal has an elongate body with a flexible wing. The brine seal is wrapped around the spiral membrane element with a space between each turn of the brine seal. The wrapped spiral wound membrane unit is placed inside a pressure housing. Between the wrapped spiral wound membrane element and an inner surface of the pressure housing is an annular space. The brine seal, the spiral wound membrane element and the pressure housing establish a bypass flow channel that spirals around the spiral wound membrane element, through the annular space. Feedstock can enter the bypass flow channel to provide sanitary flushing of the annular space. Some of the feedstock in the bypass flow channel enters the spiral wound membrane to improve the efficiency of the spiral wound membrane element.

### FIELD

The present disclosure relates generally to spiral wound membrane elements.

### BACKGROUND

The following discussion is not an admission that anything discussed below is citable as prior art or common general knowledge.

Typically, a spiral wound membrane element is made by wrapping one or more membrane leaves around a perforated central tube. One edge of a feed carrier sheet is placed in a fold of a generally rectangular membrane sheet. The fold of the membrane sheet is positioned along a perforated central tube. A permeate carrier sheet is provided between each pair of membrane sheets. Glue lines seal the permeate carrier sheet between adjacent membrane sheets along three edges, forming a membrane leaf. The fourth edge of the leaf is open to the perforated central tube. All of the sheets are wrapped around the perforated central tube.

In use, the spiral wound membrane element is housed in a pressure housing, also referred to as a pressure tube or a pressure vessel. A pressurized feedstock is delivered at an upstream end of the pressure housing and flows into the spiral wound membrane element. Within the spiral wound membrane element, the pressurized feedstock flows through the feed spacer sheets and across the surface of the membrane sheets. The membrane sheets may have a discriminating layer that is suitably sized for microfiltration, ultrafiltration, reverse osmosis or nanofiltration. A portion of the pressurized feedstock is driven through the discriminating layer by transmembrane pressure to produce a permeate stream. The permeate stream flows along the permeate carrier sheets into the central tube for collection outside the pressure housing. The components of the pressurized feedstock that do not pass through the membrane, also referred to as retentate, continue to move through the feed spacer sheets to be collected at a downstream end of the pressure housing.

Some specific industries (for example the dairy industry) require sanitary spiral wound membrane elements that meet the requirements of the Sanitary 3A Standards for Crossflow Membrane Modules. Sanitary problems can arise in areas of low flow, also referred to as areas of tight tolerance. In areas of tight tolerance, there is limited fluid access and therefore limited flushing to remove solids or provide sanitization solutions. One region that typically has low flow is between an inner surface of the pressure housing and the outer surface of the spiral wound membrane element, referred to as the annular space.

In some modules a portion of the feedstock flow is sent through the annular space. This is referred to as bypass flow. Bypass flow improves flushing of the annular space; however, the bypass flow also reduces the volume of feedstock that passes through the spiral wound membrane element to contribute to the production of permeate.

Various factors affect permeate production including temperature, osmotic pressure gradients, polarization layer, the charge of materials, fouling and the balance of fluid pressures across the membrane sheets, referred to as transmembrane pressure. The pressure of the feedstock within the feed spacer sheets influences the transmembrane pressure. As the permeate volume increases, the pressure and velocity of the feedstock within the feed spacer sheets decreases. Furthermore, the flow of feedstock through the feed spacer sheets is exposed to resistance, which is a source of head loss. Due to the volume loss of the feedstock and the head loss, the pressure and velocity of the feedstock within the feed spacer sheet decreases along the length of the spiral wound membrane element. This decreased feed spacer sheet pressure decreases the transmembrane pressure and decreases overall permeate production. The decreased velocity reduces disruption of the polarization layer at the membrane surface, which further reduces permeate production.

Typically, more than one spiral wound membrane element is housed in one pressure housing. For example, in the dairy industry between one and ten spiral wound membrane elements can be housed in one pressure housing. The multiple spiral wound membrane elements are connected in series and they typically share a common central tube. A standard dairy feedstock is introduced into the upstream end of the pressure housing at a pressure of about 100 psi. Along the length of a given spiral wound membrane element, the feed spacer sheet pressure may decrease about 5 to 10 psi. This pressure decrease can accumulate when multiple spiral wound membrane elements are used in one pressure housing and decrease the production of permeate within a given pressure housing.

### SUMMARY

A sanitary brine seal for use with spiral wound membrane elements is described below. A brine seal extends from the outside of a membrane element to the inside of a pressure vessel thus blocking flow through the annular space. In conventional practice, brine seals are provided as a ring on an end of the membrane element to prevent, or minimize, bypass flow. The brine sanitary seal described in this specification, however, is wrapped in a spiral around a membrane element. The sanitary brine seal does not attempt to close the ends of the annular space, but instead it provides a longer and narrower passage for bypass flow through the annular space. The sanitary brine seal may be shaped such that the bypass flow presses the sanitary brine seal against the inside of the pressure vessel. The sanitary brine seal may also reinforce the element. The bypass flow passage may communicate with feed spacers of the spiral wound membrane element.

One brine seal has a bottom surface that is adjacent to a portion of an outer layer of the spiral wound membrane element. A first edge faces a downstream end of the spiral wound membrane element. A second edge of the brine seal faces an upstream end of the spiral wound membrane. A protruding part extends away from the spiral wound membrane element. Successive wraps of the brine seal around the spiral wound membrane element maintain a distance between the first edge of one wrap and the second edge of a neighboring wrap. Across this distance, the outer layer of the spiral wound membrane or a porous sleeve or a spacer around the membrane element, is exposed.

When in use, the spiral wound membrane element is housed inside a pressure housing, either alone or in series with other spiral wound membrane elements. Pressurized feedstock is introduced into a feed end of the pressure housing. A portion of the pressurized feedstock enters the spiral wound membrane element and a portion provides a bypass flow. The bypass flow flushes the annular space between an inner surface of the pressure housing and the spiral wound membrane element. The bypass flow may push against and move the protruding part. For example, the protruding part may be pushed into contact with the inner surface of the pressure housing. This may help create a seal between the brine seal and the pressure vessel, accommodate variations in the outer diameter of the spiral wound membrane element or help centralize the spiral wound membrane element within the pressure housing.

The brine seal defines a lateral boundary of a bypass flow channel within the annular space. An upper boundary of the bypass flow channel is defined by the inner surface of the pressure housing and a lower boundary is defined by the exposed outer layer of the spiral wound membrane element. The bypass flow channel extends along and around the spiral wound membrane element from the feed end of the pressure housing to an output end.

In normal operation, the pressure in the feed spacer sheets decreases along the length of the spiral wound membrane element. This pressure drop decreases the transmembrane pressure and decreases the production of permeate. Therefore, a pressure gradient may develop between the feedstock in the bypass flow channel and the feedstock within the feed spacer sheets. Without being bound by theory, this pressure gradient may cause the feedstock within the bypass flow channel to enter the spiral wound membrane element. The flow of feedstock from the bypass flow channel into the spiral wound membrane element increases the flow rate of the feedstock within the feed spacer sheet. The increased flow rate of feedstock within the feed spacer sheet may contribute to increasing the transmembrane pressure, and therefore permeate production may also increase. Optionally, however, the outer surfaces of the membrane element may be impermeable. In this case, the brine seal provides an increased velocity per unit of bypass flow to allow for a more efficient, or effective, flush of the annular space.

Within the pressure housing, operational pressure and temperature conditions during filtration physically stress the structural integrity of the spiral wound membrane element. For example, the layers of the spiral wound membrane elements may shift along the longitudinal axis and the layers may also expand radially. These structural changes decrease permeate production. The physical stress on the structural stability of the spiral wound membrane element can also increase during high temperature or chemical solvent based sanitization procedures. Optionally, part of the brine seal is sufficiently rigid and optionally pre-stressed to reinforce the structural integrity of the spiral wound membrane element and withstand the physical stresses associated with filtering operations and sanitization procedures.

### BRIEF DESCRIPTION OF THE DRAWINGS

FIG. 1 is a top-plan view of a brine seal.

FIG. 2 is a cross-section view taken along line 2-2′ of FIG. 1.

FIG. 3 is a side view of the brine seal of FIG. 1 wrapped around a spiral wound membrane element.

FIG. 4 is a mid-line schematic drawing of the spiral wound membrane element and the brine seal of FIG. 3 within a pressure housing.

### DETAILED DESCRIPTION

A brine seal for use with a spiral wound membrane element is described below. At least a part of the brine seal extends from the outside of a spiral wound membrane element into an annular space inside of a pressure housing. The brine seal has an elongate body, longer than the circumference of the spiral wound membrane element, and extends simultaneously around the circumference and along the length of the spiral wound membrane element. A bypass flow is created that is oblique to the length of the spiral wound membrane element. The brine seal may extend across the annular space such that essentially all of the bypass flow is oblique to the length of the spiral wound membrane element.

The FIGS. 1 to 4 depict a brine seal 10 for use with a spiral wound membrane element having a preferred but optional cross-sectional shape that accommodates variations in the spiral wound membrane element diameter while encouraging an effective seal with the inside of the pressure vessel. This brine seal has an elongate body comprising a wing and, optionally, a reinforcing member.

The brine seal 10 is an elongate body comprising a wing 14 and a reinforcement member 16. The brine seal 10 has a first edge 18, a second edge 20, a first end 19, a second end 21, a top surface 22 and a bottom surface 24. Part of the cross-section of the brine seal is angled into the direction of bypass flow.

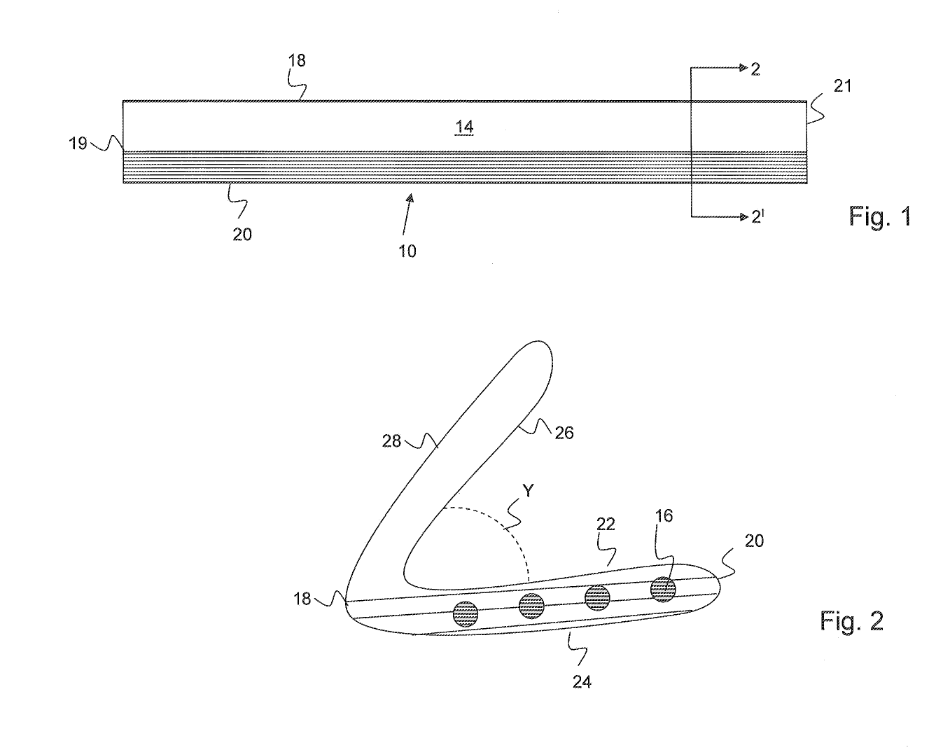

As shown in FIG. 2, the wing 14 extends away from the top surface 22, at the first edge 18. The wing 14 is an integral part of the brine seal 10. Optionally, the wing 14 can be a separate component that is positioned proximal to, or upon the brine seal 10. The wing 14 has an upstream surface 26 and a downstream surface 28. As will be discussed further below, the brine seal 10 is made from materials that allow the wing 14 to move about the first edge 20 so that the upstream surface 26 moves closer or further away from the top surface 22. This movement changes the angle between the upstream surface 26 and the top surface 22. The angle is represented by the dotted line Y in FIG. 2.

As described further below, the brine seal 10 is wrapped around a dairy spiral wound membrane element 100 and housed within a pressure housing 150. Optionally, the brine seal 10 is compressed between the spiral wound membrane element and the pressure housing 150 and this compressive force helps hold the brine seal 10 in the wrapped position. Optionally, the first end 19 and the second end 21 may be clamped in place by a clamp, or other suitable methods (not shown) that holds the brine seal 10 in the wrapped position around the spiral wound membrane 100. In this case, the brine seal 10 will hold the wrapped position during filtration operations and sanitization procedures. Optionally, the reinforcement member may be shape pre-formed so that it is pre-stressed when the brine seal 10 is installed on the spiral wound membrane element 100. Two or more of these options may be used together.

FIG. 2 depicts the optional reinforcement member 16 encapsulated, or housed, within the brine seal 10 between the top surface 22 and the bottom surface 24. When housed within the brine seal 10, the reinforcement member 16 can be made of a variety of suitably rigid materials, such as stainless steel, aluminum, copper, titanium, gold, platinum, carbon fibers, glass fibers, thermoplastic fibers and cellulose fibers. The reinforcement member 16 can be a wire or wire-like structure, that is twisted, intermeshed, woven, or not. The reinforcement member 16 can also be other suitable structures, such one or more bands, sheets or a layered fabric. The reinforcement member 16 is sufficiently rigid to help hold the brine seal 10 in a given position during filtering operations and sanitization procedures.

Optionally, the reinforcement member 16 is a coiled spring that, in the relaxed position, has an inner diameter slightly smaller than the outer diameter of the spiral wound membrane element 100. In this case, the reinforcement member 16 can be uncoiled to increase the inner diameter sufficiently to allow the brine seal 10 to be positioned along the length of the spiral wound membrane element 100 and released. The release will cause the reinforcement member 16 to return to the relaxed position and help hold the brine seal 10 in the wrapped position during filtration operations and sanitization procedures.

Optionally, the reinforcement member 16 is external to, and fixed to, the brine seal 10. In this option, the reinforcement member 16 is composed of rigid materials that meet food contact standards, for example, 300 series stainless steel can be used. When external to the brine seal 10, the reinforcement member 16 can be any of the suitable structures described above. However, a suitable external structure is limited by the material used and the manner in which the reinforcement member 16 is fixed to brine seal 10. When external to the brine seal 10, the reinforcement member 16 can be fixed to any of, or any combination of, the first edge 18, the second edge 20, the first end 19, the second end 21, the top surface 22 and the bottom surface 24. The external reinforcement member 16 is fixed to the brine seal 10 by any suitable method or technique that will withstand the stresses associated with standard operational and sanitization procedure conditions.

The brine seal 10 can be constructed of a number of suitable materials that meet food contact standards. Examples of suitable materials include thermoplastic polymers such as: polypropylene, low density polyethylene, high density polyethylene, ethylene propylene diene monomer, fluroelastomer, polyvinylidene fluoride, polytetrafluroethylene and urethanes.

FIG. 3 depicts the brine seal 10 wrapped helically, spirally, or generally around and along the longitudinal axis (shown by arrow X) of a spiral wound membrane element 100. The bottom surface 24 of the brine seal 10 is adjacent to an outer layer 116 of the spiral wound membrane element 100. The brine seal 10 is oriented with the second edge 20 and the upstream surface 26 facing an upstream end 104 of the spiral wound membrane element 100. The first edge 22 and the down stream surface 28 face a downstream end 106 of the spiral wound membrane element 100. The reinforcement member 16 (not shown in FIG. 3) holds the brine seal 10 in the wrapped position.

The brine seal 10 forms a series of turns 12 around the spiral wound membrane element 100. The series of turns 12 are shown in FIG. 3 as individual turns 12a, 12b, 12c and 12d. An individual turn is considered to extend between points of the same angular position on adjacent wrappings of the second edge 20. The number of turns 12 in the series can be variable and may depend upon the dimensions of the spiral wound membrane element 100. Optionally, but preferably, a gap 32 is provided between adjacent turns 12. The gap 32 defines the width of the bypass channel and may provide fluid communication with the spiral wound membrane element 100, which may be porous in all, or part of, its outer surface. For example, the gap 32 is shown in FIG. 3 between the first edge 18 at turn 12b and the second edge 20 at turn 12a. The width of the gap 32 is substantially constant through the series of turns 12. Alternatively, the width of the gap 32 may be different between the individual turns. For example, the width of the gap 32 within turn 12a may be wider, or narrower, in comparison to the width of the gap 32 within turn 12d. Optionally, the gap 32 may get progressively narrower, or wider, towards the downstream end 106 of the spiral wound membrane element 100. Preferably, the gap 32 get progressively narrower towards the downstream end 106. Optionally, the brine seal may extend along only a part of the length of the membrane element 100.

The spiral wound membrane element 100 has an upstream end 104 and a downstream end 106. As will be discussed further below, the upstream end 104 receives the pressurized feedstock. The downstream end 106 is the end of the spiral wound membrane element 100 where a permeate flow (not shown) and a retentate flow (not shown) are collected. The brine seal 10 is oriented upon the spiral wound membrane element 100 with the first edge 18 closest to the upstream end 104 and the second edge 20 closest to the downstream end 106.

The spiral wound membrane element 100 wraps around the central tube 108. The spiral wound membrane element 100 comprises a mixed layer 110 of multiple layers of membrane leaves. The mixed layer 110 is formed by wrapping the membrane leaves around the central tube 108 so that each of the membrane sheet, the permeate carrier sheet and the feed spacer sheet have one edge that is close to the central tube 108 and one edge that is distal from the central tube 108. At the periphery of the mixed layer 110, distal to the central tube 108, is an outer layer 116. The outer layer 116 comprises the distal edges of the membrane leaves. In the outer layer 116, the distal edges of the feed spacer sheets extend to and optionally past the distal edges of the membrane sheet and permeate carrier sheet of a membrane leaf. The distal edge of one feed spacer sheet can terminate on the feed spacer sheet of another membrane leaf. In that case, the outer layer 116 comprises feed spacer sheets that cover the distal edges of the membrane sheets and permeate carrier sheets and the feed spacer sheets provide fluid communication with the mixed layer 110 below. The feed spacer sheets prevent the distal edges of one membrane leaf from coming in direct contact with another leaf. Direct contact between the distal edges of different membrane leaves can create unsanitary areas of tight tolerance.

Optionally, the feed spacer sheets do not terminate on other feed spacer sheets, rather each feed spacer sheet terminates before covering the distal edge of a membrane leaf. However, in this case the feed spacer sheets still prevent the distal edges of different membrane leaves from coming in direct contact, while providing fluid communication with the mixed layer 110.

Adjacent the outer layer 116 is the brine seal 10. Optionally, a cage, net or other porous sleeve (not shown) can be positioned between the outer layer 116 and the brine seal 10. The cage can be made of similar materials as the feed spacer sheets, optionally of larger dimensions. The cage can assist in structurally reinforcing the mixed layer 110 and the outer layer 116. Optionally, the cage is made from polypropylene or polyethylene, or similar materials. In this option, the first edge 18 and the second edge 20 can be thermally bonded together, for example by ultrasonic welding. Optionally, the brine seal 10 can be bonded to the cage to reinforce the structural stability of the brine seal 10, the cage and the spiral wound membrane element as a whole.

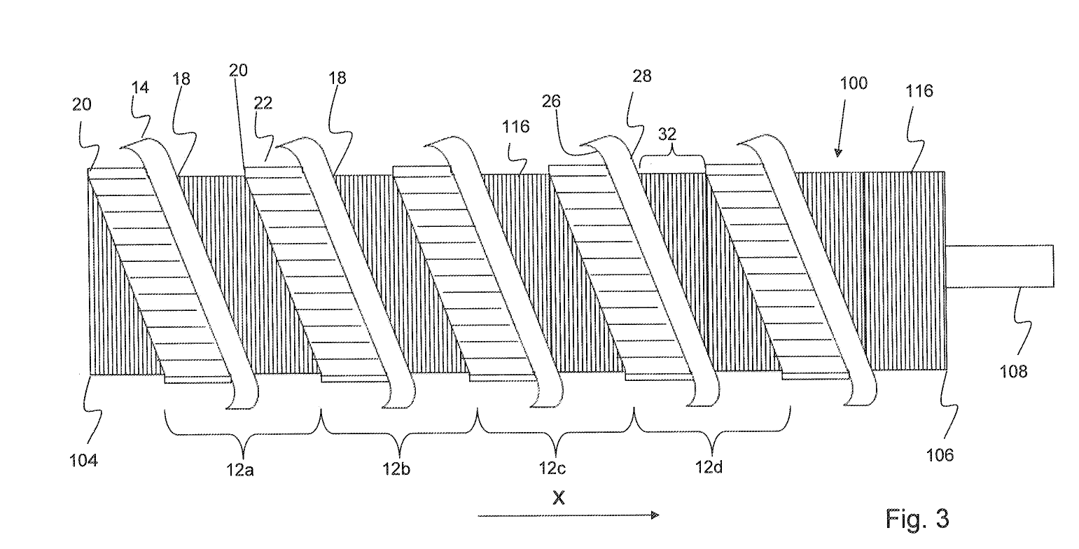

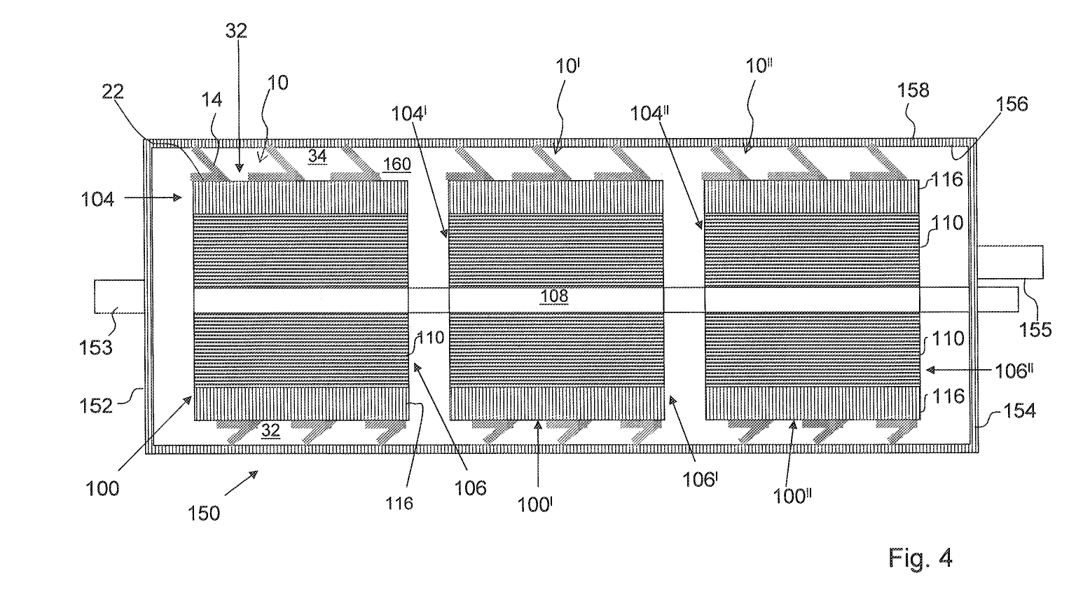

FIG. 4 depicts three spiral wound membrane elements 100, 100¹, 100¹¹ positioned within a pressure housing 150. The pressure housing 150 has an upstream end 152 with an inlet pipe 153 and a down stream end 154 with an outlet pipe 155. The pressure housing 150 is tubular in shape with an inner surface 156 and an outer surface 158.

Each spiral wound membrane element 100, 100¹, 100¹¹ is wrapped by a brine seal 10, 10¹, 10¹¹. The three spiral wound membrane elements 100, 100¹, 100¹¹ are connected in series and share a common central tube 108. Although only three spiral wound membrane elements 100 are shown in FIG. 3, there can be four to eight, or more, spiral wound membrane elements 100 within a given pressure housing 150.

The helical wrapping of the brine seal 10 in combination with the spiral wound membrane element 100 and the pressure housing 150 define a bypass flow channel 34 that extends through the annular space 160. The bypass flow channel 34 is defined by the wing 14, and the top surface 22 adjacent turns of the brine seal 10, the inner surface 156 of the pressure housing 150 and the outer surface of the spiral wound membrane element 100 exposed in the gap 32. As shown in FIGS. 3 and 4, the outer layer 116 of the spiral wound membrane 100 is exposed at the gap 32, which allows fluid communication between the bypass flow channel 34 and the outer layer 116 of the spiral wound membrane element 100.

In operation, the inlet pipe 153 introduces a pressurized feedstock (not shown) at the upstream end 152 of the pressure housing 150. This creates a pressure gradient within the pressure housing 150 that drives the feedstock from the upstream end 152 towards the down stream end 154, along the longitudinal axis of the pressure housing 150. At least a portion of the pressurized feedstock enters the first spiral wound membrane element 100 at the upstream end 104. The portion of pressurized feedstock enters and travels through the feed spacer sheets of the spiral wound membrane element 100. A portion of the pressurized feedstock leaves the feed spacer sheets and crosses the membrane sheet to form a permeate stream. The permeate stream flows through the permeate carrier sheets of the membrane leaves to be collected in the central tube 108. The remaining pressurized feedstock within the feed spacer sheets forms the retentate stream, which continues to flow through the feed spacer sheets and exits the first spiral wound membrane element 100 at the downstream end 106.

A portion of the retentate will enter the second spiral wound membrane element 100¹ at the upstream end 104¹. This portion of the retentate stream proceeds through the second spiral wound membrane element 100¹ forming a second permeate stream and a second retentate stream. The second permeate stream is collected in the central tube 108. The second retentate stream exits the second spiral wound membrane element 100¹ at the down stream end 106¹ and at least a portion of the second retentate stream enters the third spiral wound membrane element 100¹¹ at the upstream end 104¹¹. The third spiral wound membrane element 100¹¹ forms a third permeate stream and a third retentate stream. The first, second and third permeate streams are collected from the central tube 108 and the third retentate stream exits the down stream end 106¹¹ and collected by the outlet pipe 155 at the downstream end 154 of the pressure housing 150.

The portion of the pressurized feedstock that does not enter the first spiral wound membrane element 100 enters the annular space 160 at the upstream end 152 of the pressure housing 150 to provide bypass flow. Due to the orientation of the brine seal 10 the bypass flow will push or hold a portion of the wing 14 against the inner surface 156 of the pressure housing 150.

As the bypass flow proceeds along the helical path of the bypass flow channel 34, the bypass flow is exposed to the pressure gradient between the annular space 160 and the outer layer 116 that develops along the longitudinal axis of the spiral wound membrane element 100. A portion of the bypass flow will pass through the gap 32 and enter the outer layer 116. When inside the outer layer 116, this portion of the bypass flow will enter the feed spacer sheets and flow into the mixed layer 116. This increases the fluid volume and pressure within the feed spacer sheets throughout the spiral wound membrane element 100, which increases the transmembrane pressure and contributes to increase permeate production.

Along the longitudinal axis of the pressure housing 150, at the downstream end 106 of the spiral wound membrane element 100, the bypass flow that does not pass through the gap 32 will mix with the retentate produced in the spiral wound membrane 100. A portion of this mixture will enter the spiral wound membrane element 100¹ and a portion will enter the annular space 160 to create a bypass flow around the spiral wound membrane element 100¹. This mixing of bypass flow and retentate flow will occur downstream of each spiral wound membrane element 100, 100¹, 100¹¹ within the pressure housing 150.

The wing 14 may face the bypass flow with the upstream surface 26 at an initial angle, relative to the top surface 22 (shown as the dotted line Y in FIG. 2), for example 30° to 60°. When pushed by water flowing in the bypass stream, the upstream surface 26 can move to a greater angle, relative to the top surface 22, for example between 45° and 90°. Alternatively, the upstream surface 26 can be bent downwards to a lower angle relative to the top surface 22, for example between 5° and 45°. Through this range of movement, the wing 14 can accommodate dimensional differences in the outer diameter of various spiral wound membrane elements 100, between different parts of a single membrane element 100, or in the diameter of the inner surface 156 of various pressure housings 150. When the wing 14 is in contact with the inner surface 156, the spiral wound membrane element can be centered within the pressure housing 150.

Of particular interest to a horizontally arranged pressure housing 150, the wing 14 may elevate the spiral wound membrane element 100 off the lower inner surface 156 of the pressure housing 150.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

What is claimed is:

1. A brine seal for use with a spiral wound membrane element, the brine seal having an elongate body with a length greater than the circumference of the spiral wound membrane element adapted to be wrapped obliquely around and along the element.

2. The brine seal of claim 1, comprising a reinforcing member.

3. The brine seal of claim 2, wherein the reinforcing member is more rigid than remainder of the brine seal.

4. The brine seal of claim 3, wherein the reinforcing member is a wire or filament embedded in the brine seal.

5. The brine seal of claim 1, having a forward leaning surface.

6. The brine seal of claim 5, wherein the reinforcement member is a band, sheet or a layered fabric.

7. The brine seal of claim 2, wherein the reinforcing member is coiled when unstressed.

8. A filtration apparatus comprising:
a. a spiral wound membrane element with a first end, a second end and an outer surface;
b. a tubular pressure housing adapted to receive a spiral wound membrane element and defining an annular space between the outer surface and an inner surface of the tubular pressure housing between the first and second end; and
c. a brine seal wrapped around the outer surface extending radially and in a direction from the first end towards the second end, the brine seal in contact with the inner surface and allowing fluid communication between the annular space and the outer surface.

9. The filtration apparatus of claim 8, wherein the brine seal defines a bypass flow channel that extends through the annular space along and around the spiral wound membrane element.

10. The filtration apparatus of claim 8, wherein the brine seal forms a series of turns around the spiral wound membrane element and each turn is separated by a gap.

11. The filtration apparatus of claim 9, wherein the gap is substantially the same size at each turn.

12. The filtration apparatus of claim 9, wherein the outer surface of the membrane element is permeable.

13. The filtration apparatus of claim 9, wherein the gap is progressively narrower towards the second end of the spiral wound membrane element.

14. The filtration apparatus of claim 9, the brine seal further comprising a rigid reinforcing member.

15. A filtration process, comprising:
a. providing a tubular filter within a housing;
b. introducing a pressurized fluid into the housing;
c. splitting the pressurized fluid into a first flow that is filtered by the tubular filter and a second flow that is oblique to the length of the tubular filter and flows between the tubular filter and the housing; and
d. diverting a portion of the second flow into the first flow.

16. The filtration process of claim 15, comprising a step of providing a brine seal a part that protrudes towards the housing to define a lateral boundary of the bypass flow channel.

17. The filtration process of claim 16, wherein the brine seal forms a series of turns around the filter separated by gaps.
